(19) United States
(12) Patent Application Publication
(10) Pub. No.: US 2023/0017395 A1
(43) Pub. Date: Jan. 19, 2023

(54) ELECTRONIC DEVICE

(71) Applicant: VIVO MOBILE COMMUNICATION CO., LTD., Dongguan (CN)

(72) Inventor: Xuerong YANG, Dongguan (CN)

(73) Assignee: VIVO MOBILE COMMUNICATION CO., LTD., Dongguan (CN)

(21) Appl. No.: 17/947,169

(22) Filed: Sep. 19, 2022

Related U.S. Application Data
(63) Continuation of application No. PCT/CN2021/078608, filed on Mar. 2, 2021.

(30) Foreign Application Priority Data
Mar. 19, 2020 (CN) 202010199521.X

(51) Int. Cl. H04M 1/02; H04N 5/225

(52) U.S. Cl. CPC H04M 1/0264; H04M 1/0256; H04N 5/225251; H04N 5/2257

(57) ABSTRACT

An electronic device includes: a device body; a camera module, where the camera module is detachably connected to a device body, when the electronic device is in a first state, the camera module is installed on the device body and the device body controls the camera module to work; and when the electronic device is in a second state, the camera module is separated from the device body and the camera module works independent of the device body or the device body controls the camera module to work; and an elastic protection piece, where the elastic protection piece is detachably connected to the camera module.

### CROSS-REFERENCE TO RELATED APPLICATIONS

The present application is a continuation of International Application No. PCT/CN2021/078608, filed on Mar. 2, 2021, which claims priority to Chinese Patent Application No. 202010199521.X, filed on Mar. 19, 2020. The entire contents of each of the above-identified applications are expressly incorporated herein by reference.

### TECHNICAL FIELD

Embodiments of the present application relate to the field of photographing technologies, and in particular, to an electronic device.

### BACKGROUND

With the advancement of technologies and the development of electronic devices, electronic devices such as smartphones and tablet computers have become indispensable products in people's lives. An electronic device usually has a photographing function to meet usage requirements of users, and the photographing function can be performed by a camera module (also referred to as a camera module set).

To improve the photographing effect of the camera module, a solution of separating the camera module from the electronic device can be adopted. When the camera module and the electronic device are separated, the camera module can work independently, so that a distance between the camera module and the electronic device can be adjusted flexibly to improve the photographing effect.

However, when the camera module is separated from the electronic device, the camera module is far away from a user. As a result, the camera module can be easily damaged by other people or animals, thereby reducing the reliability of the camera.

### SUMMARY

The embodiments of the present application provide an electronic device, including

a device body;

a camera module, where the camera module is detachably connected to the device body, when the electronic device is in a first state, the camera module is installed on the device body and the device body controls the camera module to work; and when the electronic device is in a second state, the camera module is separated from the device body, and the camera module works independent of the device body or the device body controls the camera module to work; and

an elastic protection piece, where the elastic protection piece is detachably connected to the camera module.

In the electronic device disclosed in the embodiments of the present application, the camera module can be connected to the device body and the device body can control the camera module to work, or the camera module can be separated from the device body to work independent of the device body or the device body controls the camera module to work.

### BRIEF DESCRIPTION OF DRAWINGS

To illustrate the technical solutions in the embodiments of the present application or the background, the accompanying drawings for the description of the embodiments or the background will be briefly introduced below.

FIG. 1 is a schematic structural diagram of an electronic device in a second state according to an embodiment of the present application;

FIG. 2 is a schematic structure diagram of a part of an electronic device in a first state according to an embodiment of the present application;

FIG. 3 is an exploded view of a part of a structure of an electronic device according to an embodiment of the present application;

FIG. 4 is an exploded view of a part of a structure of an electronic device according to another embodiment of the present application;

FIG. 5 and FIG. 6 are schematic diagrams of a part of a structure of an electronic device from different viewing angles according to still another embodiment of the present application;

FIG. 7 is a schematic structural diagram of an electronic device in a second state according to another embodiment of the present application; and

FIG. 8 is a schematic diagram of a part of a structure of the electronic device shown in FIG. 7.

Reference numerals in the accompanying drawings are as follows:

100—camera module, 110—camera bracket, 120—camera, 200—device body, 210—accommodating slot, 300—elastic protection piece, 310—first protection body, 311—first connecting part, 312—first surface, 320—second protection body, 321—second connecting part, 330—hollow part, 340—counterweight part, 350—avoidance hole, 400—base, and 500—elastic piece.

### DETAILED DESCRIPTION

The following describes the technical solutions in the embodiments of the present application with reference to the accompanying drawings. Apparently, the described embodiments are some rather than all of the embodiments of the present application. All other embodiments obtained by a person of ordinary skill in the art based on the embodiments of the present application without creative efforts shall fall within the protection scope of the present application.

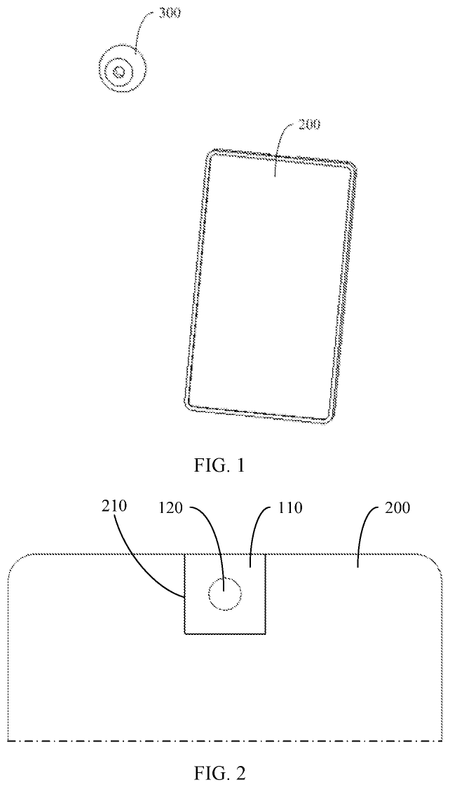

As shown in FIG. 1 to FIG. 3, an embodiment of the present application discloses an electronic device, including a device body 200, a camera module 100, and an elastic protection piece 300.

The device body 200 can be used as the body of the electronic device. The device body 200 can include components such as a casing, a main board, a battery, and a display screen. The embodiments of the present application do not limit the specific structure of the device body 200.

The camera module 100 is detachably connected to the device body 200. Therefore, the camera module 100 can be connected to the device body 200 or detached from the device body 200. When the electronic device is in a first state, the camera module 100 is installed on the device body 200. In this case, the device body 200 can control the camera module 100 to work, and the camera module 100 can perform data transmission with the device body 200, so that an image captured by the camera module 100 is transmitted to the device body 200. When the electronic device is in a second state, the camera module 100 is separated from the device body 200. In this case, the camera module 100 works independent of the device body 200, and a user can directly control the camera module 100 to perform photographing operations; or the device body 200 can control the camera module 100 to work. In this state, the camera module 100 can also perform data transmission with the device body 200, to transmit an image captured by the camera module 100 to the device body 200.

The elastic protection piece 300 has elasticity. In some embodiments, the elastic protection piece 300 may be made of an elastic material (for example, silica gel), and the elastic protection piece 300 can be deformed after being subject to a force, to play a buffering role. The elastic protection piece 300 is detachably connected to the camera module 100, so that the elastic protection piece 300 can be connected to the camera module 100 or separated from the camera module 100. When the elastic protection piece 300 is connected to the camera module 100, the elastic protection piece 300 can cover at least a part of the camera module 100; when the elastic protection piece 300 is separated from the camera module 100, the camera module 100 can be freely installed on other components (for example, the device body 200).

In the electronic device, the camera module 100 can be connected to the device body 200 and the device body 200 can control the camera module 100 to work, or the camera module 100 can be separated from the device body 200 to work independent of the device body 200 or the device body 200 controls the camera module 100 to work. Therefore, the user can flexibly adjust the placement position of the camera module 100 to perform long-distance photographing, so that the photographing effect of the camera module 100 is better. At the same time, when the camera module 100 is separated from the device body 200, the elastic protection piece 300 can be connected to the camera module 100, so that the elastic protection piece 300 can protect the camera module 100 and prevent the camera module 100 from being damaged by external force. Therefore, the reliability of the camera module 100 is higher.

In an embodiment, the camera module 100 may include a camera bracket 110, a camera 120, a battery, and a first data transmission module. The camera 120, the battery, and the first data transmission module are all arranged on the camera bracket 110. In some embodiments, the battery and the first data transmission module can be arranged on the surface of the camera bracket 110 or inside the camera bracket 110. To better protect the battery and the first data transmission module, the battery and the first data transmission module can be arranged inside the camera bracket 110. The battery can be electrically connected to the camera 120. Therefore, the battery can supply power to the camera 120, so that the camera 120 can work independently. The first data transmission module is electrically connected to the camera 120, so that data transmission can be performed between the camera 120 and the first data transmission module. When the camera module 100 is separated from the device body 200, the camera 120 performs data transmission with the device body 200 through the first data transmission module. In some embodiments, the device body 200 may be correspondingly provided with a second data transmission module. When the electronic device is in the second state, the first data transmission module and the second data transmission module perform data transmission, and the camera 120 performs data communication with the device body 200 through the first data transmission module, so as to perform data transmission between the camera module 100 and the device body 200. In an embodiment, both the first data transmission module and the second data transmission module herein can be wireless transmission modules, such as radio frequency modules, and this structure does not limit relative positions of the camera module 100 and the device body 200. Therefore, it is more convenient for users to use the electronic device.

When the camera module 100 adopts the above structure, the elastic protection piece 300 can be detachably connected to the camera bracket 110. When the electronic device is in the second state, the elastic protection piece 300 is connected to the camera bracket 110. In some embodiments, the elastic protection piece 300 may be connected to the outer surface of the camera bracket 110. Since the camera bracket 110 is the main structure of the camera module 100, when the elastic protection piece 300 is connected to the outer surface of the camera bracket 110, the elastic protection piece 300 covers the camera module 100 to a greater extent, thereby achieving a better protection effect.

In some embodiments, the elastic protection piece 300 is provided with an accommodating cavity and an avoidance hole 350, and the accommodating cavity and the avoidance hole 350 are communicated with each other. When the electronic device is in the second state, at least a part of the camera bracket 110 and at least a part of the camera 120 are located in the accommodating cavity, and the camera 120 faces the avoidance hole 350, so that light in the external environment can enter the camera 120 through the avoidance hole 350, thereby helping the camera 120 to perform a photographing operation. In this case, the size of the elastic protection piece 300 is larger, and the elastic protection piece 300 can cover most of the outer surface of the camera bracket 110, so that the camera module 100 is less likely to come into contact with other objects, and the elastic protection piece 300 can better withstand external forces. Therefore, the protection effect of the elastic protection piece 300 is better.

In some embodiments, the shape and size of the accommodating cavity can be matched with the shape and size of the camera module 100, so that the elastic protection piece 300 can better cover the camera module 100, so as to better protect the camera module 100.

The elastic protection piece 300 may adopt an integrated structure, but such an integrated structure does not facilitate connection and disconnection of the elastic protection piece 300 and the camera module 100. Based on this, in an embodiment, to facilitate the connection and disconnection of the elastic protection piece 300 and the camera module 100, the elastic protection piece 300 may include a first protection body 310 and a second protection body 320. When the electronic device is in the second state, the first protection body 310 and the second protection body 320 are connected to form the accommodating cavity. In some embodiments, both the first protection body 310 and the second protection body 320 may be provided with grooves, the camera module 100 may be placed in the groove of the first protection body 310 or the second protection body 320, and then the first protection body 310 is connected to the second protection body 320 to protect the camera module 100. Otherwise, when the elastic protection piece 300 and the camera module 100 need to be separated, the camera module 100 can be taken out after the first protection body 310 and the second protection body 320 are disconnected.

A method for connecting the first protection body 310 to the second protection body 320 can be selected flexibly, for example, the first protection body 310 and the second protection body 320 can be bound by a connecting rope. However, in this method, the connecting rope can be easily disconnected from the first protection body 310 and the second protection body 320, resulting in poor reliability of connection between the first protection body 310 and the second protection body 320. Therefore, in other embodiments, the first protection body 310 is provided with a first connecting part 311, and the second protection body 320 is provided with a second connecting part 321. When the electronic device is in the second state, the first connecting part 311 is connected to the second connecting part 321. This connection method is more reliable, so that the first protection body 310 and the second protection body 320 are not easily separated unexpectedly.

There may be one first connecting part 311 and one second connecting part 321. However, to further improve the reliability of the connection between the first protection body 310 and the second protection body 320, multiple first connecting part 311 and multiple second connecting part 321 can be arranged, and each of the first connecting parts 311 cooperates with each of the second connecting parts 321 in a one-to-one correspondence.

In some embodiments, the first protection body 310 has a first surface 312, the first connecting part 311 is arranged on the first surface 312, the second protection body 320 has a second surface, and the second connecting part 321 is arranged on the second surface. When the electronic device is in the second state, the first face 312 faces the second face. When the first protection body 310 and the second protection body 320 are connected, the first connecting part 311 and the second connecting part 321 are both in a hidden state, and are not easily separated by interference from other objects in the external environment. Therefore, this structure can further improve the reliability after the first protection body 310 and the second protection body 320 are connected. At the same time, this solution can also optimize the appearance and texture of the camera module 100 when the camera module 100 works independently, thereby improving user experience.

In an embodiment, both the first surface 312 and the second surface can be arranged as flat surfaces, so as to simplify the structure of the elastic protection piece 300.

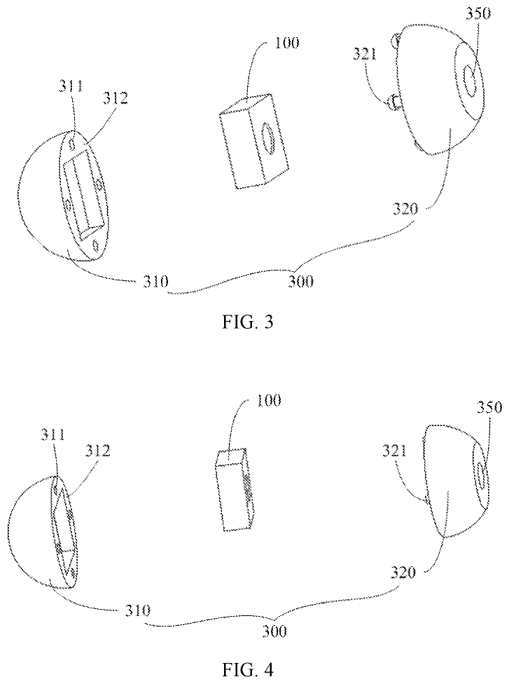

In an embodiment, as shown in FIG. 3, one of the first connecting part 311 and the second connecting part 321 is a clamping hole, the other is a clamping convex part, and the clamping hole and the clamping convex part can be snap-fitted, so that the first protection body 310 and the second protection body 320 can be snap-fitted through the clamping hole and the clamping convex part. This connection method has advantages of higher connection strength and simpler operation. Further, the material of the clamping convex part herein may be different from the material of another part of the first protection body 310 or the second protection body 320. In some embodiments, for example, the first protection body 310 is provided with a clamping convex part. The first protection body 310 may include a body and a clamping convex part as described herein. The clamping convex part is provided on the body, and has hardness that may be greater than that of the body, so that the clamping convex part is less likely to greatly deform while satisfying snap-fitting. Therefore, the connection strength of the first protection body 310 and the second protection body 320 is higher, and at the same time, it is more conducive to faster clamping of the clamping hole and the clamping convex part.

Of course, in other embodiments, as shown in FIG. 4, the first connecting part 311 and the second connecting part 321 may be suitable magnetic connecting parts, and in some embodiments, the magnetic connecting parts here may be permanent magnets. This structure enables the first connecting part 311 and the second connecting part 321 to be magnetically connected, so as to achieve the purpose of magnetically connecting the first protection body 310 and the second protection body 320. In this connection method, it is more convenient to arrange the structures of the first connecting part 311 and the second connecting part 321, so that the structure of the electronic device is simpler, and the connection of the first protection body 310 and the second protection body 320 is facilitated.

The shape of the first protection body 310 and the second protection body 320 can be selected flexibly. In some embodiments, the first protection body 310 and the second protection body 320 are both spheres. In some embodiments, the first protection body 310 and the second protection body 320 are both hemispheres, and after the first protection body 310 and the second protection body 320 are connected, the outer surface of the entire elastic protection piece 300 is a spherical surface. When the first protection body 310 and the second protection body 320 are connected, the placement position of the entire elastic protection piece 300 is more flexible, so that the orientation of the camera module 100 connected to the elastic protection piece 300 can be flexibly changed, to better meet the photographing requirements of users in different states. At the same time, the structure allows the user to hold the elastic protection piece 300 more comfortably.

When the camera module 100 is separated from the device body 200, the position of the camera module 100 affects the photographing experience. For example, if the camera module 100 is inverted, the image captured by the camera module 100 is inverted, and the user needs to adjust this image, resulting in poor user experience. In view of this, in an embodiment, when the electronic device is in the second state, the center of gravity of the elastic protection piece 300 is located outside the optical axis of the camera 120, that is, the elastic protection piece 300 may be eccentrically arranged relative to the camera module 100, and under the action of gravity, the camera module 100 can be kept at a predetermined position, so that obtained images are more convenient for users to view and use. After this arrangement, the user does not need to spend too much time to place the camera module 100 and the elastic protection piece 300, and the user is even allowed to throw the elastic protection piece 300 and the camera module 100 to a designated position. Therefore, the structure is more convenient for the user to perform a photographing operation in the second state.

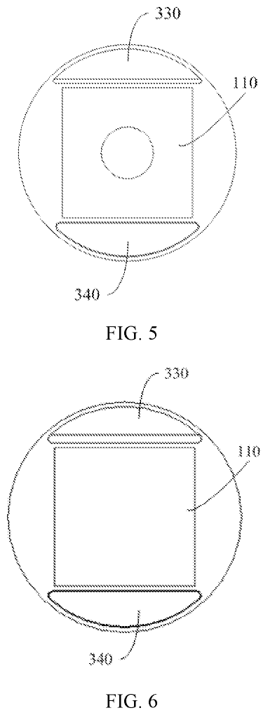

To make the center of gravity of the elastic protection piece 300 located outside the optical axis of the camera 120, in an embodiment, as shown in FIG. 5 and FIG. 6, the elastic protection piece 300 is provided with a hollow part 330. When the electronic device is in the second state, the hollow part 330 is located above the optical axis of the camera 120. In this structure, the density of a part of the elastic protection piece 300 where the hollow portion 330 is arranged is different from the density of another part of the elastic protection piece 300, so that the weight of the part of the elastic protection piece 300 where the hollow portion 330 is arranged is smaller than that of the another part of the elastic protection piece 300. Therefore, the center of gravity of the elastic protection piece 300 is moved downward relative to the geometric center of the elastic protection piece 300, so as to avoid the optical axis of the camera 120 as much as possible. At the same time, this embodiment can also appropriately reduce the weight of the elastic protection piece 300, so as to be more convenient for the user to operate.

Still referring to FIG. 5 and FIG. 6, in other embodiments, to make the center of gravity of the elastic protection piece 300 be located outside the optical axis of the camera 120, the elastic protection piece 300 may be provided with a counterweight part 340. In some embodiments, the density of the counterweight part 340 may be greater than the density of the rest of the elastic protector 300, for example, the weight portion 340 may be a metal piece. When the electronic device is in the second state, the weight portion 340 is located below the optical axis. In this structure, the weight of the part of the elastic protection piece 300 where the counterweight part 340 is arranged is greater than that of another part of the elastic protection piece 300. Therefore, the center of gravity of the elastic protection piece 300 is moved downward relative to the geometric center of the elastic protection piece 300, so as to avoid the optical axis of the camera 120 as much as possible. At the same time, in this embodiment, the elastic protection piece 300 is a solid structure, which has a higher structural strength and is not easily deformed. Therefore, the protection effect is better.

Of course, both the hollow part 330 and the counterweight part 340 can also be provided in the elastic protection piece 300, so that the center of gravity of the elastic protection piece 300 deviates from the geometric center of the elastic protection piece 300 to a greater extent. Therefore, the camera module 100 can be better kept in a predetermined position more stably.

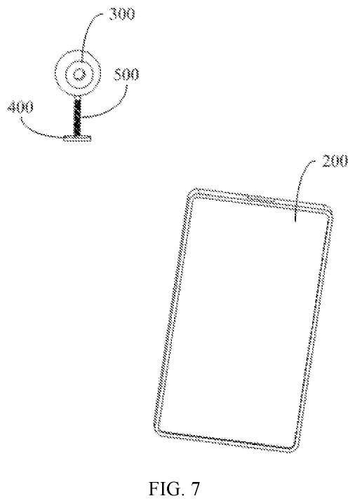

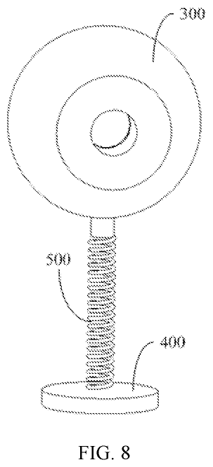

As shown in FIG. 7, the camera module 100 further includes a base 400 having a support surface. When the electronic device is in the second state, the elastic protection piece 300 is connected to a side of the base 400 away from the support surface. When the electronic device is in the second state, the elastic protection piece 300 can be placed on a placing base such as a ground surface or a table surface, and the support surface herein can be in contact with the placing base, so that the elastic protection piece 300 can be stably placed on the placing base through the base 400, so that the camera module 100 can be kept at a predetermined position.

Further, the support surface can be arranged as a flat surface, so as to achieve a better supporting effect.

The base 400 can be directly connected to the elastic protection piece 300. In other embodiments, the camera module 100 further includes an elastic piece 500, and the elastic piece 500 is connected to the base 400. In some embodiments, the elastic piece 500 herein can be a spring. When the electronic device is in the second state, the base 400 is connected to the elastic protection piece 300 through the elastic piece 500. The elastic piece 500 can be elastically deformed. When the elastic protection piece 300 collides with other objects, although the elastic protection piece 300 shakes, a part of the elastic piece 500 connected to the elastic protection piece 300 can move synchronously when the elastic protection piece 300 shakes, and an end of the elastic protection piece 300 connected to the base 400 can remain stationary or only shake slightly. Therefore, this structure makes the base 400 not easy to move, so that the camera module 100 and the elastic protection piece 300 are not easily toppled. Thus, the stability of the camera module 100 in the second state is improved. Therefore, when the elastic piece 500 is provided, the camera module 100 can be placed at a position far away from the user for photographing, so as to further optimize usage experience of the user.

In some embodiments, the camera module 100 further includes a magnetic part connected to the elastic protection part 300, and when the electronic device is in the second state, the elastic protection part 300 can be magnetically connected to an external component through the magnetic part. In some embodiments, the magnetic part may be arranged on the surface of the elastic protection piece 300 or inside the elastic protection piece 300; and the magnetic part may be a permanent magnet, which may adopt a sheet-like structure to improve the magnetic attraction effect. When the electronic device is in the second state, the user can fasten the entire elastic protection piece 300 and camera module 100 on any magnetically conductive external component (such as an iron plate) through the magnetic part, so as to better maintain the position of the camera 120 relative to the user. This magnetic method enables the user to fasten the camera module 100 more quickly, and at the same time, the connection method has less structural restrictions on external components, so that the fastening position of the camera module 100 has more options.

In an embodiment, the device body 200 is provided with an accommodating slot 210, and the camera module 100 is provided with a second data transmission module. When the electronic device is in the first state, at least a part of the camera module 100 is located in the accommodating slot 210, and the camera 120 performs data communication with the device body 200 through the second data transmission module. In this embodiment, when the camera module 100 is connected to the device body 200, the camera module 100 can be arranged by using the space occupied by the device body 200, so that a protruding degree of the camera module 100 relative to the device body 200 is smaller, and even does not protrude. This arrangement can not only improve the appearance and texture of the electronic device, but also prevent the camera module 100 from easily colliding with other objects due to protruding relative to the device body 200, thereby protecting the camera module 100.

In some embodiments, the device body 200 is provided with a first interface, the first interface may be arranged in the accommodating slot 210, and the second data transmission module includes an electrical connection end. When the electronic device is in the first state, the electrical connection end is plugged into the first interface, thereby realizing data transmission between the electrical connection end and the first interface. In this plug manner, the electrical connection end and the first interface are not easily detached, thereby improving the reliability of the connection between the electrical connection end and the first interface.

In another embodiment, the electrical connection end and the first interface are both magnetic contacts, and when the electronic device is in the first state, the electrical connection end is magnetically connected to the first interface. This connection method can simplify the connection between the electrical connection end and the first interface, thereby realizing the quick connection between the camera module 100 and the device body 200. In some embodiments, to further enhance the reliability of the connection between the electrical connection end and the first interface, both the electrical connection end and the first interface can be arranged as annular magnetic contacts to increase the connection area of the electrical connection end and the first interface, so as to achieve the above purpose.

In some embodiments, the first interface can be a charging interface. When the camera module 100 is connected to the device body 200, the device body 200 can charge the camera module 100, thereby ensuring the battery life of the camera module 100, so as to facilitate subsequent usage of the camera module 100. In some embodiments, the first interface is a data transmission interface, and the data transmission interface can realize data transmission. Of course, the first interface can also be used as a charging interface and a data transmission interface at the same time, thereby simplifying the structure of the electronic device. In some embodiments, the first interface here may be a USB interface, for example, may be a Micro USB interface or the like.

The electronic device disclosed in this embodiment of the present application may be a smart phone, a tablet computer, an ebook reader, a wearable device (for example, a smart watch), a video game console, and the like. A specific type of the electronic device is not limited in this embodiment of the present application.

The embodiments of the present application focus on describing differences between the embodiments, and different optimization features of the embodiments may be combined to form better embodiments provided that they are not contradictory. Considering brevity, details are not described herein again.

The foregoing descriptions are merely embodiments of the present application, and are not intended to limit the present application. For a person skilled in the art, various changes and variations may be made in the present application. Any modifications, equivalent substitutions, improvements, and the like made within the spirit and principle of the present application should be included within the scope of the claims of the present application.

1. An electronic device, comprising:
a device body;
a camera module set, wherein the camera module set is detachably connected to the device body, when the electronic device is in a first state, the camera module set is installed on the device body and the device body controls the camera module set to work; and when the electronic device is in a second state, the camera module set is separated from the device body, and the camera module set works independent of the device body or the device body controls the camera module set to work; and
an elastic protection piece, wherein the elastic protection piece is detachably connected to the camera module set.

2. The electronic device according to claim 1, wherein the camera module set comprises:
a camera bracket;
a camera, wherein the camera is arranged on the camera bracket;
a battery, wherein the battery is arranged on the camera bracket, and the battery is electrically connected to the camera; and
a first data transmission module set, wherein the first data transmission module set is arranged on the camera bracket, and the first data transmission module set is electrically connected to the camera;
wherein the elastic protection piece is detachably connected to the camera bracket, and when the electronic device is in the second state, the camera performs data communication with the device body through the first data transmission module set, and the elastic protection piece is connected to the camera bracket.

3. The electronic device according to claim 2, wherein the elastic protection piece is provided with an accommodating cavity and an avoidance hole, and when the electronic device is in the second state, at least a part of the camera bracket and at least a part of the camera are located in the accommodating cavity, and the camera faces the avoidance hole.

4. The electronic device according to claim 3, wherein the elastic protection piece comprises a first protection body and a second protection body, and when the electronic device is in the second state, the first protection body is connected to the second protection body to form the accommodating cavity.

5. The electronic device according to claim 4, wherein the first protection body is provided with a first connecting part, the second protection body is provided with a second connecting part, and when the electronic device is in the second state, the first connecting part is connected to the second connecting part.

6. The electronic device according to claim 5, wherein the first protection body has a first surface, the first connecting part is arranged on the first surface, the second protection body has a second surface, the second connecting part is arranged on the second surface, and when the electronic device is in the second state, the first face faces the second face.

7. The electronic device according to claim 5, wherein one of the first connecting part and the second connecting part is a clamping hole, and the other is a clamping convex part; or
the first connecting part and the second connecting part are matched magnetic connecting parts.

8. The electronic device of claim 4, wherein the first protection body and the second protection body are both hemispheres.

9. The electronic device according to claim 1, wherein when the electronic device is in the second state, the center of gravity of the elastic protection piece is located outside the optical axis of the camera.

10. The electronic device according to claim 9, wherein the elastic protection piece is provided with a hollow part, and when the electronic device is in the second state, the hollow part is located above the optical axis.

11. The electronic device according to claim 9, wherein the elastic protection piece is provided with a counterweight part, and when the electronic device is in the second state, the counterweight part is located below the optical axis.

12. The electronic device according to claim 1, wherein the camera module set further comprises a base, the base has a support surface, and when the electronic device is in the second state, the elastic protection piece is connected to a side of the base away from the support surface.

13. The electronic device according to claim 12, wherein the camera module set further comprises an elastic piece, the elastic piece is connected to the base, and when the electronic device is in the second state, the base is connected to the elastic protection piece through the elastic piece.

14. The electronic device according to claim 1, wherein the camera module set further comprises a magnetic part, the magnetic part is connected to the elastic protection piece, and when the electronic device is in the second state, the elastic protection piece is magnetically connected to an external component through the magnetic part.

15. The electronic device according to claim 1, wherein the device body is provided with an accommodating slot, the camera module set is provided with a second data transmission module set, and when the electronic device is in the first state, at least a part of the camera module set is located in the accommodating slot, and the camera performs data communication with the device body through the second data transmission module set.

16. The electronic device according to claim 15, wherein the device body is provided with a first interface, and the second data transmission module set comprises an electrical connection end; and
when the electronic device is in the first state, the electrical connection end is plugged into the first interface; or
both the electrical connection end and the first interface are magnetic contacts, and when the electronic device is in the first state, the electrical connection end is magnetically connected to the first interface.
